(19) United States
(12) Patent Application Publication
(10) Pub. No.: US 2018/0215003 A1
(43) Pub. Date: Aug. 2, 2018

(54) A CUTTING APPARATUS

(71) Applicant: THE SHODA COMPANY, Hamamatsu City, Shizuoka (JP)

(72) Inventor: Hiroshi SHODA, Hamamatsu City, Shizuoka (JP)

(21) Appl. No.: 15/320,711

(22) PCT Filed: Sep. 16, 2015
(86) PCT No.: PCT/JP2015/076239

§ 371 Date: Dec. 20, 2016

(51) Int. Cl. B23Q 11/08; B23C 3/12; B23Q 3/06

(52) U.S. Cl. CPC B23Q 11/08; B23Q 3/06; B23C 3/12

(57) ABSTRACT

To provide a cutting apparatus capable of effectively removing swarf that scatters in a machining space, while reducing cost.

A cutting apparatus includes: a machining mechanism on which a tool for machining a workpiece is mounted; a placement base that is disposed to face the machining mechanism in a machining space and that is movable in a first direction with the workpiece placed thereon; an open/close covering member that extends in the first direction thereby to contain therein the placement base and to form at least part of the machining space; and a drive mechanism that is isolated from the machining space and that moves the placement base in the first direction.

### TECHNICAL FIELD

The present invention relates to a cutting apparatus capable of machining a workpiece as an object to be machined using a tool including a desired tool.

### BACKGROUND ART

In general, a cutting apparatus that machines a relatively large-sized workpiece, represented, for example, by a numerical control (NC) router mainly includes a machining mechanism that performs a predefined machining operation with respect to a workpiece such as a router head and a boring head, and a placement member having a placement surface on which a workpiece can be mounted. In a machining operation of the workpiece, the workpiece is first positioned and fixed on a machining table on the placement surface using, for example, a clamping device and then the machining mechanism is moved as necessary in an X-axis direction, a Y-axis direction, and a Z-axis direction, so that a tool mounted in the machining mechanism performs the machining operation with respect to the workpiece.

In the known cutting apparatus described above, swarf is scattered all around because of the machining operation being performed using a tool on the workpiece placed on the placement member. A cutting machine that cuts a workpiece, in particular, produces a large amount of swarf from the workpiece during machining. A need thus arises to perform cleaning at predetermined time intervals.

A gas jet device may, for example, be provided as a solution. The gas jet device may be computer-controlled, so that a gas can be automatically jetted out from above a workpiece downward. This solution blows swarf toward an intended direction and can prevent the swarf from being scattered around to some degree. Such a known technique is not, however, related to invention known to the public through publication and no information is currently available concerning prior art documents.

### SUMMARY

### Technical Problems

The following problems are, however, anticipated to achieve a cutting apparatus as described above.

First, a cost problem. Comparing the machining center as a machine tool, the above-described NC router, for example, generally machines large-sized workpieces. Thus, the majority of the known NC routers are what is called an open type having no covers for covering external structures thereof. The foregoing contrasts to a closed type covering the external structure, representing a major portion of the machining centers described above.

An approach may then be possible toward closing a machining space as in the machining center and incorporating a computer-controlled gas jet device in the machine to thereby create downflow as described above. This configuration requires that a relatively large-sized gas jet device be disposed on a ceiling of the machining space or that compact but a plurality of gas jet devices be disposed on the ceiling of the machining space in order to generate a uniform airflow inside the machining space. Additionally, to create such downflow, the gas jet device or the like needs to be disposed on the ceiling side of the machining space. To further ensure above-described movement of the machining mechanism, the machining apparatus is unavoidably built large.

It is common knowledge in the industry that, with the cutting apparatus represented by the NC router, scattering of dust particles is unavoidable to some degree despite a dust collector of some sort mounted therein but achieving only a marginal effect. Moreover, because of the size involved of the apparatus, larger than the machining center described above, a simple exterior cover invites an increased size and cost. Such a background has dampened industry's desire to develop into the closed type.

Second, entry of swarf in a drive mechanism. A possible configuration including the computer-controlled gas jet device disposed inside the machine as described above may indeed offer high convenience because of capability of automatically clearing areas around the workpiece of swarf through a simple operation; however, the cleaning is not meticulously effective. As described above, the machining mechanism includes a drive mechanism (also known as a drive unit) including gears and bearings for moving the machining mechanism relative to the placement surface. The swarf can enter the drive mechanism with the above-described gas jet device. The swarf entering the drive mechanism not only adversely affects machining accuracy of the workpiece, but also leads to a worn drive mechanism and, in some cases, a broken drive mechanism.

The present invention has been made to solve the above-described problems, for example, and it is an object of the present invention to provide a cutting apparatus capable of appropriately removing swarf that scatters in a machining space, while reducing cost.

### Solution to Problems

To solve the above-described problems, a cutting apparatus in an aspect of the present invention (1) includes: a machining mechanism that machines a workpiece; a placement base that is disposed to face the machining mechanism in a machining space and that is movable in a first direction with the workpiece placed thereon; an open/close covering member that extends in the first direction thereby to contain therein the placement base and to form at least part of the machining space; and a drive mechanism that is isolated from the machining space and that moves the placement base in the first direction.

The cutting apparatus of (1) described above preferably (2) further includes an exterior covering member connected with the open/close covering member to thereby cover the machining mechanism; and in the cutting apparatus of (1), the machining mechanism is movable in a second direction that is orthogonal to the first direction.

In the cutting apparatus of (1) or (2) described above, preferably (3) the open/close covering member has an opening formed in an upper surface thereof and a variable cover is disposed in the opening, and the variable cover is deformed as the machining mechanism moves in the second direction, to thereby maintain a closed state in the machining space.

In the cutting apparatus of any of (1) to (3) described above, preferably (4) a flexible surrounding cover is disposed around the machining mechanism and a bottom portion cover is disposed at a lower portion of the surrounding cover; the bottom portion cover surrounds at least a leading end portion of the machining mechanism; and, the flexible surrounding cover is deformed as the machining mechanism moves in a third direction that crosses the first direction and the second direction, to thereby maintain a closed state in the machining space.

In the cutting apparatus of any of (1) to (4) described above, preferably (5) the open/close covering member includes a slide cover that is capable of relative movement in the second direction, and the open/close covering member can be opened or closed through the movement of the slide cover in the second direction.

In the cutting apparatus of (5) described above, preferably (6) a partial cover has a work hole and includes a manipulator disposed at the work hole.

In the cutting apparatus of (6) described above, preferably (7) a fluid control unit is further provided that is disposed inside the machining space and that is capable of jetting or drawing a fluid. In the cutting apparatus of (6) above, the manipulator is shaped to reach the fluid control unit.

In the cutting apparatus of any of (1) to (7) described above, preferably (8) a screen member that isolates the drive mechanism from a machining space in which the placement base is disposed. In the cutting apparatus of any of (1) to (7) above, the screen member follows movement of the placement base in the first direction to thereby be displaced, thereby maintaining an isolated state of the drive mechanism from the machining space.

In the cutting apparatus of any of (1) to (8) described above, preferably (9) the drive mechanism rotatably supports the placement base from an outside of the machining space.

### Advantageous Effect of Invention

According to the present invention, the machining space in which the workpiece is machined is defined and a workpiece machining operation can be performed in the machining space isolated from a drive mechanism. Swarf can thus be efficiently removed and can further be prevented from entering the drive mechanism.

### BRIEF DESCRIPTION OF DRAWINGS

FIG. 1 is a perspective view depicting an appearance of a cutting apparatus according to a first embodiment.

FIG. 2 is a perspective view depicting an appearance of the cutting apparatus according to the first embodiment, from which an exterior covering member and an open/close covering member are removed.

FIG. 3 is a perspective view depicting the cutting apparatus according to the first embodiment from which a slide door of the open/close covering member is open.

FIG. 4 is a perspective view depicting details of a drive mechanism that drives a placement base in the cutting apparatus according to the first embodiment.

FIG. 5 is a perspective view depicting a structure for isolating the drive mechanism from a machining space including the placement base in the cutting apparatus according to the first embodiment.

FIG. 6 is a perspective view depicting the structure for isolating the drive mechanism from the machining space including the placement base in the cutting apparatus according to the first embodiment from which the slide door of the open/close covering member is open.

FIG. 7 is a perspective view for illustrating an arrangement of the placement base and a screen member in the cutting apparatus according to the first embodiment.

FIG. 8 is a perspective view for illustrating an arrangement of a suction mechanism and the screen member in the cutting apparatus according to the first embodiment.

FIG. 9 is a perspective view for illustrating an arrangement of a leg portion of the placement base and an isolation unit in the cutting apparatus according to the first embodiment.

FIG. 10 is a diagram for illustrating a structure in which a drive unit of a machining mechanism is isolated from the machining space in the cutting apparatus according to the first embodiment.

FIG. 11 is a perspective view depicting the machining mechanism, the placement base, and the drive mechanism in the cutting apparatus according to the first embodiment, as viewed from an inside of the open/close covering member.

FIG. 12 is a schematic view for illustrating a structure with which the machining mechanism is isolated from the machining space in a Y direction and a Z direction in the cutting apparatus according to the first embodiment.

FIG. 13 is a schematic view illustrating a mount having a suction unit in a cutting apparatus according to a second embodiment.

FIG. 14 is a schematic view depicting an open/close covering member in a cutting apparatus according to a first modification.

FIG. 15 is a schematic view depicting an open/close covering member in a cutting apparatus according to a second modification.

FIG. 16 is a perspective view depicting the open/close covering member in the cutting apparatus according to the second modification.

FIG. 17 is a schematic view depicting a cutting apparatus according to a third modification.

### DESCRIPTION OF EMBODIMENTS

Embodiments of the present invention will be described in detail below with reference to the accompanying drawings.

The following exemplarily illustrates a cutting apparatus that performs a cutting operation among other cutting apparatuses that can suitably embody the present invention. Understandably, the present invention can also be applied to, for example, a griding apparatus that performs a grinding operation and other types of cutting apparatuses that produce swarf (cutting chips, grinding chips, and the like) through machining of workpieces, in addition to the cutting apparatus.

It is noted that, in addition to configurations and functions of a cutting apparatus ME to be detailed hereunder, mechanisms disclosed in, for example, Japanese Patent Laid-open No. 2010-46781 and Japanese Patent Laid-open No. 2010-5710 may be applied as appropriate without departing from the spirit of the present invention.

### First Embodiment

The cutting apparatus ME according to a first embodiment is capable of machining a workpiece using a predetermined tool (not depicted). The cutting apparatus ME includes at least a machining mechanism 1, a placement base 2, an open/close covering member 3, and a drive mechanism 4.

It is noted that, as depicted in FIG. 1, the cutting apparatus ME according to the present embodiment further includes an exterior cover 10 that houses thereinside at least the machining mechanism 1. The exterior cover 10 and the open/close covering member 3 constitute an appearance of the cutting apparatus ME.

For convenience sake, in the following, a direction in which the placement base moves is defined as an X direction (a first direction), a direction in which the machining mechanism moves is defined as a Y direction (a second direction orthogonal to the first direction), and a height direction is defined as a Z direction (a third direction orthogonal to the first direction and the second direction). Such definitions are not, however, intended to be limiting of the invention.

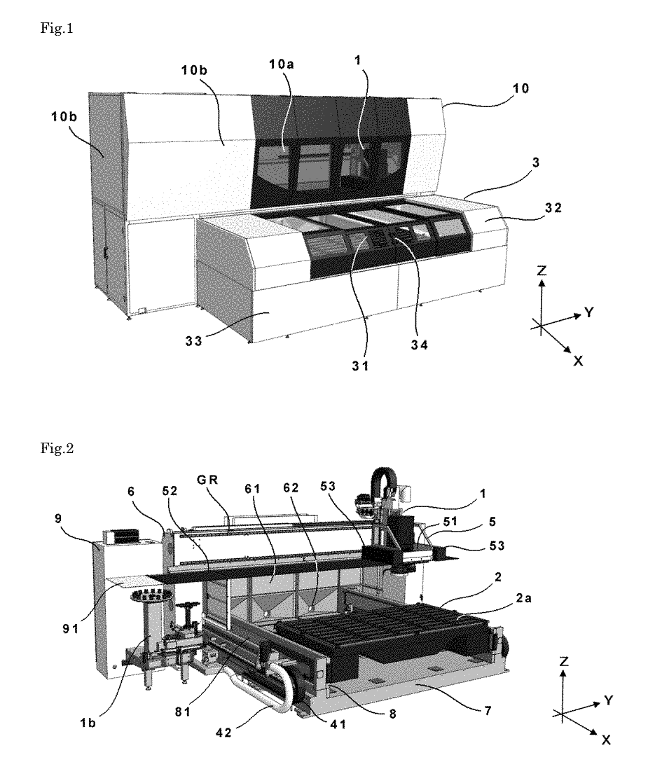

As depicted in FIG. 2, the machining mechanism 1 is a machining head on which a tool (not depicted) for machining a workpiece, for example, a router is mounted. Using this tool, the machining mechanism 1 machines the workpiece placed on the placement base 2 into a desired shape. It is noted that the machining mechanism 1 may be provided with a Z drive mechanism, not depicted, that brings the tool close to or away from the placement base 2. The machining mechanism 1 may even be provided with a revolving mechanism, not depicted, that rotates the tool about at least one of the X-axis direction (Xθ), the Y-axis direction (Yθ), and the Z-axis direction (Zθ).

The machining mechanism 1 is guided by a frame 5 to be described later and a guide GR of a double housing column 6 so as to be movable along the Y direction (second direction) above the placement base 2 by a drive mechanism (to be described later) such as a servomotor as controlled by a control unit 9.

Examples of the workpieces suitable for the present embodiment include, but are not limited to, wooden articles (e.g., wooden pieces and wooden plates), metal articles (e.g., metal pieces and metal plates), and engineering plastics and other resins (e.g., resin pieces and resin plates).

The tool to be mounted on the machining mechanism 1 is required only to be capable of cutting the workpiece and may be configured in any style including cutters. Nonetheless, an optimum shape and an optimum material of the cutter are selected according to the material of the workpiece.

The machining mechanism 1 may be further provided with a jet port (not depicted) from which a gas, such as air, is jetted out toward the placement base 2 or the workpiece. The machining mechanism 1 may be controlled so as to jet a fluid (gas or liquid) toward the placement base 2 from the jet port as appropriate during traveling in the Y direction.

Alternatively, the machining mechanism 1 may have a suction port (not depicted) through which a gas in areas around the tool in a machining space WS (to be detailed later) is drawn. The machining mechanism 1 may then be controlled so as to draw swarf through this suction port during, for example, machining of the workpiece. The above-described suction port provided in the machining mechanism 1 allows a suction operation through the suction port to serve also as a cooling function to cool the machining mechanism 1. Understandably, a fan or a blower for cooling the machining mechanism 1 may be separately mounted regardless of whether the machining mechanism 1 has such a suction port.

Additionally, the machining mechanism 1 may include an automatic tool changer (ATC) 1b. In this case, the ATC 1b is housed, for example, inside the exterior cover 10 and outside the machining space WS. In this case, a housing that houses therein the control unit 9 includes a roof member 91 disposed at an apex of the ATC 1b as depicted in FIG. 2. The roof member 91 will be detailed later.

Preferably, the ATC 1b houses a cleaning brush that can replace the tool mounted at a leading end portion t of the machining mechanism 1. At this time, when the machining mechanism 1 has the suction port as described above, replacing the tool with the cleaning brush and rotating the brush allow dust particles on the placement base 2 to be efficiently drawn after machining.

The Y direction (second direction) in which the machining mechanism 1 travels is not limited to a direction orthogonal to the X direction (first direction) in which the placement base 2 moves. The Y direction (second direction) is required only to cross the first direction.

The frame 5 is a machine structure formed of, for example, well-known alloy or steel for machine structure use. A take-up unit 53 (to be described later) and other parts are mounted on the frame 5 such that movement of the machining mechanism 1 in the Y direction is not hampered. The frame 5 in the present embodiment is mounted on the double housing column 6 via the guide GR. The frame 5 is configured so as to be capable of traversing with the placement base 2 in the Y direction. The frame 5 may nonetheless be configured so as to support the machining mechanism 1.

The configuration in the present embodiment in which the machining mechanism 1 and the frame 5 move relative to the double housing column 6 via the guide GR is illustrative only and not limiting. An alternative exemplary configuration includes a frame unit (not depicted) newly added to extend across the placement base 2 and a rail not depicted disposed on an upper surfaced of the frame unit, so that the machining mechanism 1 can slide along the Y direction via the rail.

The double housing column 6 is formed of, for example, well-known alloy or steel for machine structure use. The double housing column 6 is a double housing solid structure that extends across the placement base 2. The double housing column 6 includes the guide GR for moving the machining mechanism 1 along the Y direction, capable of moving in the Y direction the frame 5 and the machining mechanism 1 that are movable via the guide GR.

In the present embodiment, the double housing column 6 includes a rear plate 61 disposed on a rear side thereof (−X direction side). The rear plate 61 is formed of, for example, metal. At least part of the rear plate 61 forms part of the machining space WS.

Additionally, the rear plate 61 has a discharge port 62 formed on a side thereof facing the above-described machining space WS. The discharge port 62 is connected with a vacuum generating source not depicted and is capable of drawing swarf and the like as controlled by the control unit 9 to be described later. It is noted that the rear plate 61 has two discharge ports 62 as depicted in FIG. 2. The number of discharge ports 62 may, nonetheless, be one, or three or more.

A structure or material of the guide GR is not limited to a particular one. A linear guide including a bearing, for example, or any other well-known mechanism may be applied thereto. Additionally, the double housing column 6 may be omitted as appropriate, when the frame 5 is given high stiffness and a Y-direction guiding function to thereby be able to support the machining mechanism 1.

The control unit 9 is a well-known computer that includes, for example, a central processing unit (CPU) having an arithmetic operation function, a memory storing various types of information, an input device (e.g., keyboard) for inputting information, and an output device (e.g., liquid crystal display) outputting and displaying information.

An operator can input optimum machining conditions for the workpiece using the input device and confirming results, for example, using the output device.

The memory may store in advance, for example, a machining program corresponding to various machining modes. In addition, the control unit 9 may be configured so as to be remotely controlled over a network.

The exterior cover 10 is formed of, for example, a metal plate. The exterior cover 10 houses therein the above-described machining mechanism 1, the frame 5, the double housing column 6, and the control unit 9. Additionally, as depicted in FIG. 1, the exterior cover 10 has a double housing shape that extends across the drive mechanism 4, a mount 7, and other parts.

It is noted that the exterior cover 10 may be at least partly formed of a transparent member (e.g., transparent resin material or glass) through which an inside thereof (e.g., the machining mechanism 1) is visible. In the example depicted in FIG. 1, a transparent member 10a having a width substantially identical to a width in the Y direction of a slide cover 31 of the open/close covering member 3 is disposed on a lateral surface 10b on the side adjacent to the slide cover 31 out of the lateral surface 10b of the exterior cover 10.

The exterior cover 10 may be fixed to the open/close covering member 3 to be described later through a well-known fixing member, such as a screw or a bolt, or through well-known fitting.

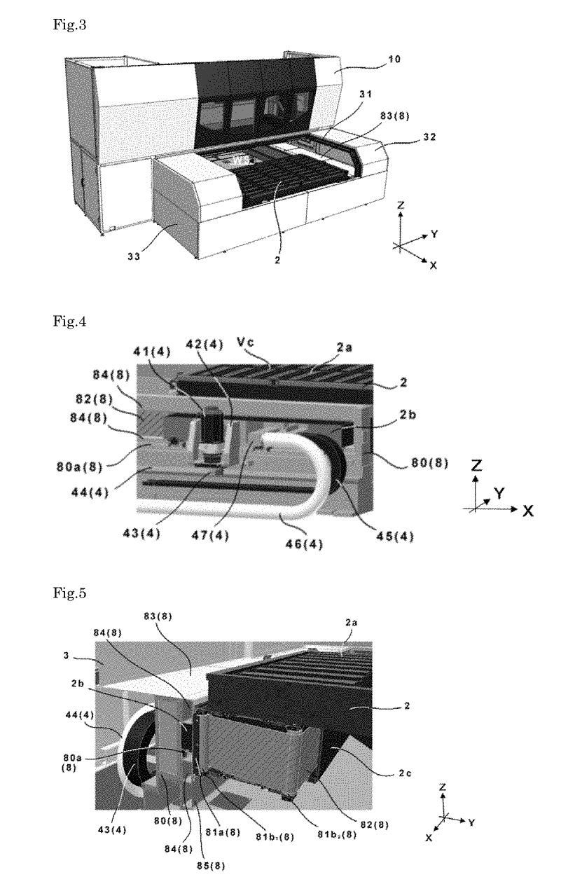

As depicted in FIGS. 2 and 3, the placement base 2 is disposed so as to face the machining mechanism 1 described above. The placement base 2 is configured so as to be movable along the X direction (first direction) with a workpiece mounted thereon.

More specifically, in the present embodiment, the placement base 2 is connected with the drive mechanism 4 disposed on the mount 7 and is capable of varying a position thereof in the X direction using the drive mechanism 4. A connection structure between the placement base 2 and the drive mechanism 4 will be detailed later using relevant drawings.

Reference is made to FIG. 4. A plurality of placement portions 2a are arrayed along the X direction and the Y direction on the upper surface of the placement base 2. The placement portions 2a each have a workpiece attraction port Vc. The workpiece attraction port Vc is connected with a vacuum generating source not depicted (e.g., vacuum pump) via a vacuum pipe 46 (to be described later). The workpiece attraction port Vc has a function of attracting a workpiece placed on the placement base 2 under control of the control unit 9. It is noted that the control unit 9 may be used to control the vacuum generating source to thereby maintain the machining space WS to be described later in a state of pressure slightly negative with respect to the outside. The foregoing arrangement can prevent, for example, swarf generated through machining of the workpiece from being discharged to the outside of the machining space WS by way an unintended path.

The mount 7 is formed of, for example, well-known steel for machine structure use. The mount 7 has a size sufficient for holding, for example, the drive mechanism 4 and an isolation unit 8 to be described later.

It is noted that, in the present embodiment, at least a portion of the mount 7 to face the placement base 2 is configured to be flat having no drive parts such as a ball screw and a linear guide. This configuration can prevent, for example, swarf produced during machining of the workpiece from being stagnant at protrusions or the like, so that the swarf can be removed via the discharge ports 62 described above.

The open/close covering member 3 extends in the X direction (first direction) so as to cover the placement base 2. In the present embodiment, the open/close covering member 3, the mount 7, and other elements form the machining space WS in which the workpiece is housed.

As evident from FIGS. 1 and 3, the open/close covering member 3 in the present embodiment includes the slide cover 31, a fixed cover 32, a lower cover 33, and a handle 34.

The slide cover 31 is disposed above the lower cover 33 so as to be slidable in the Y direction (second direction). At least part of the slide cover 31 is formed of a transparent resin material, such as acryl, so that the above-described machining space WS is visible. Additionally, the handle 34 is disposed on the slide cover 31. The operator holds the handle 34 to thereby slidingly move the slide cover 31. This operation changes a state of the machining space WS from a closed state to an open state.

The fixed cover 32 has a space in which the slide cover 31 can be housed when the slide cover 31 is slidingly moved in the Y direction. The fixed cover 32 is disposed on both ends in the Y direction out of an entire portion above the lower cover 33. The material for the fixed cover 32 is not limited to a particular one. A resin plate or a metal plate, for example, may be suitable for the material of the fixed cover 32.

The lower cover 33 is disposed so as to surround the mount 7 and the drive mechanism 4 to be described later. The material for the lower cover 33 is not limited to a particular one. A well-known material, such as a resin plate or a metal plate, may be used as with the fixed cover 32.

FIG. 3 depicts a condition in which the slide cover 31 is housed inside the fixed cover 32, specifically, the slide cover 31 is open.

In the present embodiment, slidingly moving the slide cover 31 to bring the machining space WS into an open state allows a workpiece to be loaded and unloaded.

When the slide cover 31 is closed, the machining space WS is brought into a closed state. Then, swarf produced from the workpiece during machining, for example, can be prevented from flying unintentionally to the outside of the machining space WS.

A structure of the drive mechanism 4 in the present embodiment will be detailed below with reference to FIG. 4. It is noted that FIG. 4 depicts the drive mechanism 4 on one side (−Y direction side). The same applies to the drive mechanism 4 on another side (+Y direction side).

The drive mechanism 4 includes, for example, a well-known rack and pinion mechanism. The rack and pinion mechanism is disposed outside the machining space WS and has a function of moving the placement base 2 in the X direction (first direction). The rack and pinion mechanism may, for example, be provided in pairs, one on one side of the placement base 2 and the other on another side of the placement base 2 in the Y direction. Each rack and pinion mechanism extends along the X-direction.

More specifically, as depict in FIG. 4, the drive mechanism 4 in the present embodiment includes at least an electric motor 41, a motor mounting portion 42, a pinion 43, and a rack 44. It is noted that, in the present embodiment, the drive mechanism 4 further includes a cableveyor 45, the vacuum pipe 46, and a mounting shaft 47.

Any of various types of well-known electric motors may be applied to the electric motor 41. The electric motor 41 is a drive source for rotatably driving the pinion 43 disposed on a drive shaft of the electric motor 41. The electric motor 41 rotatably drives the pinion 43 under the control of the control unit 9 described above to thereby be capable of positioning the placement base 2 at any position in the X direction. It is noted that a position detection sensor (not depicted) that can detect a position of the placement base 2 in the X direction is not required to be disposed at a particular position. For example, the position detection sensor may be disposed at a position at which the position detection sensor can detect a reference member (e.g., marking) of the placement base 2. The position detection sensor may even be configured so as to detect rotation of the pinion 43.

The motor mounting portion 42 is fixed to a leg portion 2b of the placement base 2 and fixedly supports the electric motor 41. The motor mounting portion 42 is fixed to the leg portion 2b of the placement base 2 by, for example, a well-known fastening method (e.g., screwing or welding). To state the foregoing differently, the motor mounting portion 42 can be said to be integrated with the placement base 2 in the present embodiment.

The pinion 43 meshes with the rack 44 to be described later and is rotatably driven by power drive of the electric motor 41.

The rack 44 is fixedly disposed on, for example, a post 80 in the present embodiment. Thus, the pinion 43 being rotatably driven on the fixed rack 44 results in the placement base 2 being driven in the X direction.

The cableveyor 45 houses therein, for example, wires of the electric motor 41 and can be deformed as the placement base 2 moves in the X direction.

The vacuum pipe 46 connects a vacuum generating source not depicted with the workpiece attraction ports Vc in the placement base 2. This configuration enables the placement base 2 to attract and hold a workpiece.

The mounting shaft 47 is a member with which the above-described vacuum pipe 46 is connected. The mounting shaft 47 has a hole (not depicted) for guiding a vacuum supplied from the vacuum pipe 46 to the workpiece attraction ports Vc. The mounting shaft 47 may have a function of holding the cableveyor 45.

A well-known roller (not depicted) is disposed on a bottom surface side of the leg portion 2b in the placement base 2. As depicted in FIG. 4, a rail 80a associated with this roller is disposed at the post 80. This configuration enables weight of the placement base 2 to be supported by the roller and the rail, so that the placement base 2 can be smoothly moved in the X direction with small drive power. It is noted that the rail 80a is not necessarily required to be disposed at the post 80. The rail 80a may be disposed, for example, on the mount 7 outside the machining space WS.

As depicted in FIG. 4, the isolation unit 8 is disposed between the placement base 2 and the drive mechanism 4 in the present embodiment.

The isolation unit 8 has a function of isolating the drive mechanism 4 from the machining space WS. Thus, the swarf produced the workpiece in the machining space WS is prevented from entering the drive mechanism 4.

The following describes in detail, with reference to FIGS. 5 to 10, a positional relation among the drive mechanism 4, the isolation unit 8, and the machining space WS. The description thereby clarifies how the drive mechanism 4 is isolated from the machining space WS via the isolation unit 8 and the like.

Reference is made to FIG. 5. The isolation unit 8 includes the post 80, a roll unit 81, a screen member 82, a partition member 83, and a suction pipe 84.

The post 80 is formed of, for example, metal material. The post 80 is disposed on the mount 7 so as to extend along the X direction as depicted in FIG. 6. The post 80 constitutes a frame unit having a void formed therein so that the leg portion 2b of the placement base 2 and the drive mechanism 4 are connected with each other. The placement base 2 is not thereby hampered from moving in the X direction by the post 80. For convenience sake, FIG. 6 depicts only part of the placement base 2 with the workpiece attraction ports Vc and the placement portions 2a, for example, omitted as appropriate.

Additionally, as described above, the rail 80a is disposed on the bottom surface that forms the void in the post 80. The roller disposed on the bottom surface side of the leg portion 2b can then be disposed on the rail 80a.

The roll unit 81 follows movement of the placement base 2 in the X direction to thereby displace the screen member 82. The roll unit 81 in the present embodiment includes a plurality of first poles 81a and a plurality of second poles 81b. The roll unit 81 in the present embodiment includes two first poles 81a disposed at respective end portions of the post 80 in the X direction. The two first poles 81a thereby support end portions of the screen member 82. The roll unit 81 in the present embodiment includes a total of four second poles 81b disposed at the placement base 2. The second poles 81b are capable of moving in the X direction integrally with the placement base 2.

The screen member 82 has a function of closing the above-described void in the above-described post 80. The screen member 82 has both ends fixed at the above-described first poles 81a. It is noted that the screen member 82 changes a direction in which the screen member 82 extends using the second poles 81b disposed at the placement base 2.

Specifically, with reference to the state depicted in FIG. 5, the screen member 82 extends along the −X direction from the first pole 81a disposed at an end portion in the +X direction. The screen member 82 then turns approximately 90 degrees at a first second pole 81b₁ disposed at the placement base 2 to thereby change an extension direction so as to extend in the +Y direction. The screen member 82 then turns approximately 90 degrees at a second second pole 81b₂ to thereby change the extension direction so as to extend in the −X direction, thus extending over a distance equivalent to a width of the placement base 2 in the X direction. The screen member 82 thereafter turns approximately 90 degrees at a third second pole 81b₃ to thereby change the extension direction so as to extend in the −Y direction. Finally, the screen member 82 turns approximately 90 degrees at a fourth second pole 81b₄ to thereby change the extension direction so as to extend in the −X direction, before extending up to the first pole 81a disposed at an end portion in the −X direction.

Thus, as depicted also in FIG. 6, the screen member 82 is turned at positions of the second poles 81b fixed at the placement base 2 and is disposed inside the placement base 2. As the placement base 2 moves in the X direction, the screen member 82 is tensioned by the second poles 81b to be displaced (deformed). The foregoing may alternatively be said that the roll unit 81 (second poles 81b) in the present embodiment, while permitting suction of the screen member 82 by the suction mechanism 84 at portions other than the leg portion 2b of the placement base 2, deforms the screen member 82 so as to avoid the leg portion 2b in the space in which the leg portion 2b is housed.

The foregoing arrangement allows the screen member 82 to maintain a closed state of the machining space WS regardless of the position of the placement base 2 in the X direction. Thus, the present embodiment can prevent entry of swarf from the machining space WS using the screen member 82 that closes the void in the above-described post 80, regardless of the position in the X direction to which the placement base 2 moves.

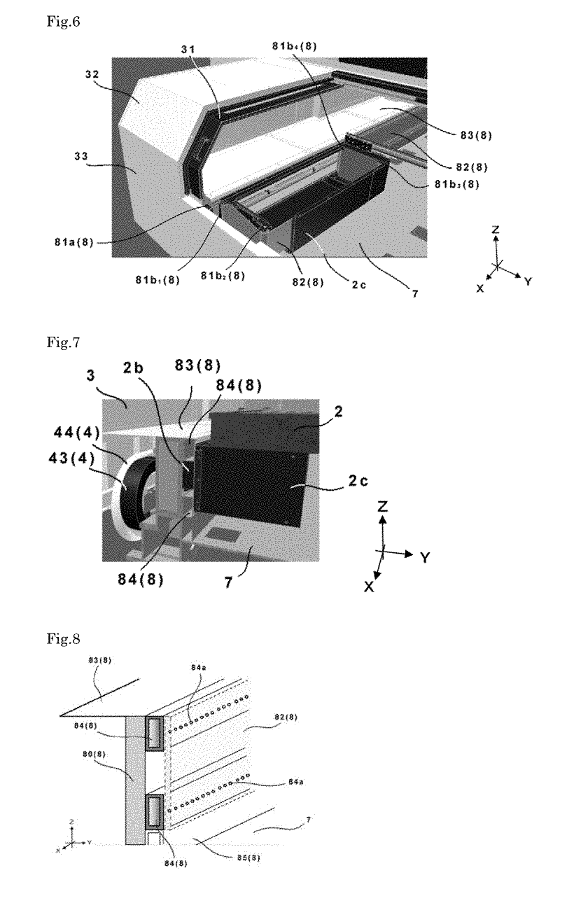

FIGS. 5 and 6 depict, for convenience sake, the screen member 82 exposed on the lateral surface in the X direction of the placement base 2. The screen member 82 may nonetheless be covered in a lateral surface cover 2c of the placement base 2 as depicted in FIG. 7. The lateral surface cover 2c can prevent the swarf produced in the machining space WS from entering a space between the screen member 82 and the roll unit 81.

Additionally, in the above-described example, the screen member 82 changes the extension direction from the first direction (X direction) to the second direction (Y direction), or vice versa, so as to avoid the leg portion 2b of the placement base 2. The change in the extension direction does not necessarily have to be substantially at right angles. The first direction and the second direction are only required to cross each other.

Various types of materials can be applied to the screen member 82. Examples of the materials for the screen member 82 include, but are not limited to, resin, such as vinyl and rubber, and cloth.

The present embodiment incorporates the roll unit 81 and one screen member 82 to isolate the drive mechanism 4 from the machining space WS. The arrangement of the screen member 82 is, however, illustrative only and not limiting and is required only to be capable of being deformed or displaced in accordance with the movement of the placement base 2 in the X direction.

For example, two expandable bellows members may be used for the screen member 82. In this case, the bellows members are disposed on both sides of the leg portion 2b in the X direction so as to close respective voids. At this time, the bellows members each have one end fixed to the leg portion 2b and another end fixed to the post 80.

Alternatively, a variable cover 52 and the take-up unit 53 (to be described later) that are mounted on the frame 5 may be diverted and the take-up unit is disposed on both sides of the leg portion 2b in the X direction so that the respective voids are closed by variable sheets. At this time, the variable sheets each have one end pulled in a winding direction by the take-up unit and another end fixed to the post 80.

The partition member 83 is a plate-shaped member disposed on an upper surface of the post 80 and extending along the X direction as with the post 80.

The partition member 83 has an end portion in the −Y direction connected with a lateral surface of the open/close covering member 3. This configuration allows the partition member 83 to prevent entry of the swarf from the machining space WS in the drive mechanism 4.

As depicted also in FIG. 7, the suction pipe 84 is disposed on a lateral surface of the post 80 on the side adjacent to the placement base 2 so as to be capable of drawing part of the screen member 82. To state the foregoing differently, the suction pipe 84 is disposed between the second poles 81b disposed at the placement base 2 and the post 80. To state the foregoing still differently, the screen member 82 can be said to be disposed so as to be clamped between part of the second poles (81b₁ and 81b₄) and the suction pipe 84.

The following describes, with reference to FIG. 8, a structure of the suction pipe 84. For ease of understanding, FIG. 8 omits some of the elements including the first pole 81a.

As depicted in FIG. 8, the suction pipe 84 in the present embodiment is, for example, a hollow metal pipe having a rectangular section. The suction pipe 84 is connected with a vacuum generating source not depicted. The suction pipe 84 is disposed on a lateral surface of the post 80 via a well-known fastener so as to extend in the X direction. It is noted that, in the present embodiment, two suction pipes 84 are disposed on the lateral surface of the post 80, one being spaced apart from the other in the Z direction so as to be associated with an upper end portion and a lower end portion of the screen member 82 in the Z direction.

The suction pipes 84 each have a plurality of suction holes 84a formed in a side thereof facing the screen member 82 and arrayed along the X direction. Action of the vacuum generating source described above causes the screen member 82 to be attracted via the suction holes 84a.

Meanwhile, the attraction of the screen member 82 by the suction pipe 84 is canceled on the surface of the suction pipe 84 facing the leg portion 2b of the placement base 2 because the screen member 82 is tensioned by the above-described roll unit 81.

As such, in areas of the void in the post 80 other than the placement base 2 (leg portion 2b), the closed state of the machining space WS is maintained by the suction pipe 84 attracting the screen member 82. In an area of the void in the post 80 which the placement base 2 (leg portion 2b) moves past, the closed state of the machining space WS is maintained by the placement base 2.

It is noted that the present embodiment includes a height adjustment member 85 disposed beneath the suction pipe 84. The height adjustment member 85 may nonetheless be omitted and a length of the suction pipe 84 in the Z direction may be adjusted or part of the mount 7 may be protruded.

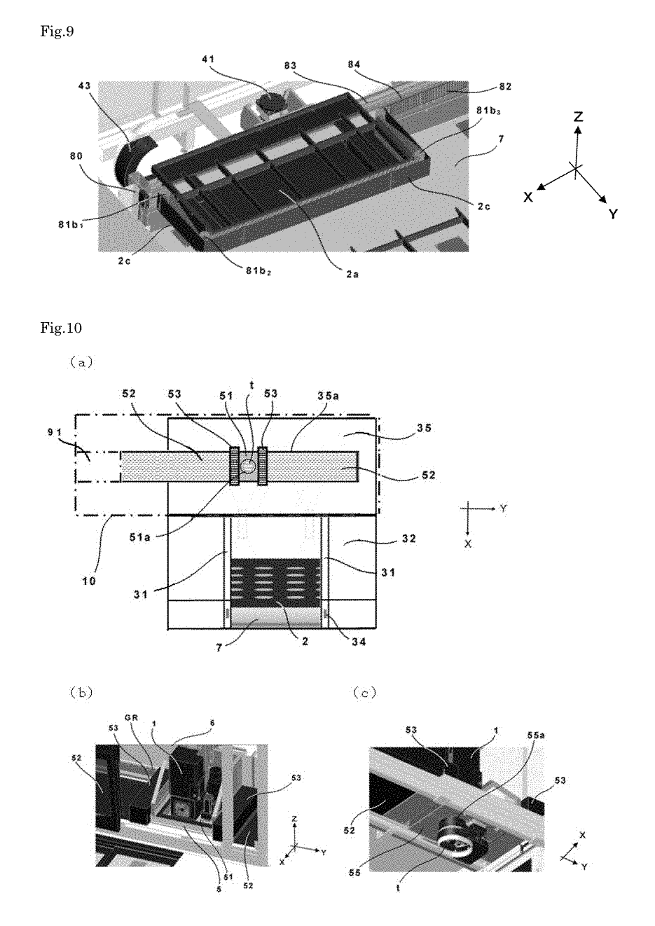

The following describes, with reference to FIG. 9, a positional relation between the leg portion 2b of the placement base 2 and the isolation unit 8.

As illustrated, the placement base 2 in the present embodiment is configured such that the upper surface of the leg portion 2b is not equal in height to the placement surface in the Z direction and a shoulder is formed such that the leg portion 2b is lower in height than the placement surface.

Thus, the second poles (81b₁ to 81b₄) disposed at the placement base 2 are disposed so as to avoid the leg portion 2b. To state the foregoing differently, the leg portion 2b of the placement base 2 is disposed in a space surrounded by the second poles 81b and the leg portion 2b is extended from this space to be connected with the drive mechanism 4 so as to extend past the void in the post 80.

As evident from the foregoing descriptions, in the present embodiment, the machining space WS in which the workpiece is machined is physically configured with the isolation unit 8 (post 80, screen member 82, partition member 83, suction mechanism 84, and the like), the open/close covering member 3, the mount 7, and other elements. The placement base 2 can be moved in the X direction particularly under a condition in which the isolation unit 8 isolates the drive mechanism 4 from the machining space WS.

Thus, the present embodiment prevents entry of the swarf produced during machining of the workpiece in the drive mechanism 4 to thereby be able to prevent failure of the drive mechanism 4. Additionally, the prevention of entry of the swarf in the drive mechanism 4 eliminates the need for frequently performing service jobs including cleaning of the drive mechanism 4. Thus, low cost and highly efficient production can be achieved.

The following describes, with reference to FIGS. 10 to 12, connection between the open/close covering member 3 and the machining mechanism 1 in the present embodiment.

FIG. 10 is a schematic view depicting the open/close covering member 3 as viewed from above.

As depicted in the figure, an upper surface plate 35 is disposed on an area facing the exterior cover 10, out of the upper surface of the open/close covering member 3 other than the slide cover 31 and the fixed cover 32.

To maintain sealing property of the above-described machining space WS in the present embodiment, the open/close covering member 3 has an opening 35a formed in an upper surface thereof and the variable cover 52 is disposed in the opening 35a. The variable cover 52 is deformed as the machining mechanism 1 moves in the Y direction (second direction), to thereby maintain the closed state in the machining space WS.

It is noted that, in the present embodiment, the ATC 1b is disposed inside the exterior cover 10. Thus, to allow the machining mechanism 1 to move up to a tool change position of the ATC 1b, the opening 35a extends up to an end portion on the −Y side of the open/close covering member 3 and the variable cover 52 has an end portion on the −Y side of the machining mechanism 1 fixed to the roof member 91 described above. It is noted that, in a configuration not including the ATC 1b, the end of the opening 35a on the −Y side may have a shape identical to a shape of the end of the opening 35a on the +Y side without the need to be extended up to the end of the open/close covering member 3.

More specifically, as depicted in FIG. 10(a), the leading end portion t of the machining mechanism 1 is positioned in the opening 35a in the upper surface plate 35 and is movable in the opening 35a in the Y direction. FIG. 10 omits a tool mounted at the leading end portion t for convenience sake.

At this time, the frame 5 has an opening 51 through which the machining mechanism 1 is housed so as to be movable in the Z direction. Additionally, a pair of take-up units 53 is disposed on the frame 5. Each of the take-up units 53 is disposed on either end in the Y direction of the machining mechanism 1. Additionally, a flexible surrounding cover 54 and a bottom plate cover 55 (to be each described later) are disposed on the inside of the opening 51, so that sealing property inside the opening 51 with respect to the machining space WS is maintained.

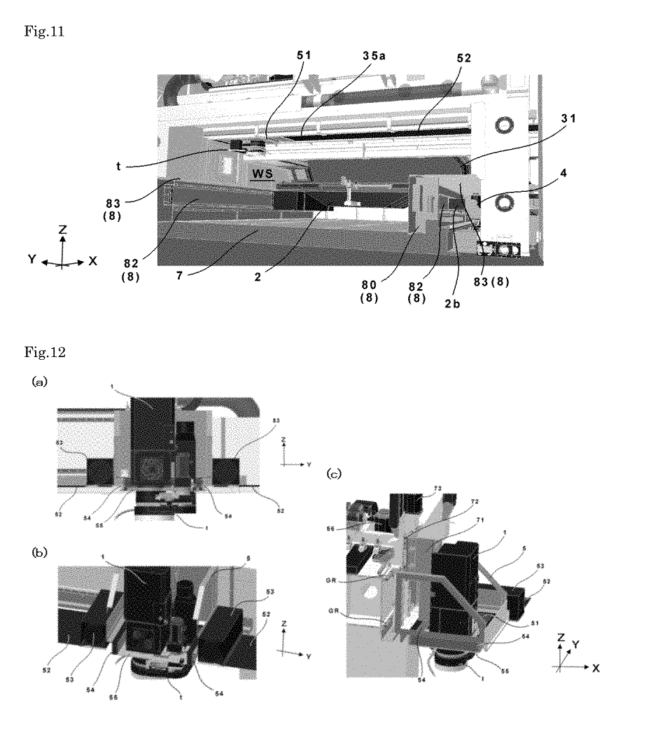

It is noted that the frame 5 is movable in the Y direction with the machining mechanism 1 as guided by the guide GR as described above; however, the frame 5 does not move in the Z direction with the machining mechanism 1 as will be later detailed with reference to FIG. 12.

Reference is made to FIG. 10(b). The take-up unit 53 includes a mechanism that takes up the variable cover 52. In the present embodiment, a take-up force is applied in advance in a direction in which the variable cover 52 is taken up.

Meanwhile, the variable cover 52 has an end portion on the side opposite to the take-up unit 53 fixed to an edge of the opening 35a in the Y direction.

In the present embodiment, the take-up unit 53 is disposed on either end of the machining mechanism 1 in the Y direction and the variable cover 52 described above has the end portion fixed to the corresponding edge of the opening 35a in the Y direction.

In addition, as evident from FIG. 10(c), a circular hole 51a is configured such that the leading end portion t of the machining mechanism 1 including the tool is guided into the machining space WS via a well-known sealing material not depicted (e.g., rubber packing and adhesive). It is noted that, for convenience sake, FIG. 10(c) omits the flexible surrounding cover 54 and the bottom portion cover 55 to be described later.

Thus, when, for example, the machining mechanism 1 is moved with the frame 5 in the +Y direction from the condition depicted in FIG. 11, the take-up unit 53 disposed on the +Y side relative to the machining mechanism 1 deforms the variable cover 52 so as to take up the variable cover 52 and the take-up unit 53 disposed on the −Y side relative to the machining mechanism 1 deforms the variable cover 52 so as to unreel the variable cover 52.

The foregoing operation causes the variable cover 52 to be deformed to follow the movement of the machining mechanism 1 even when the machining mechanism 1 moves in the Y direction, thereby maintaining sealing property of the machining space WS.

It is noted that a mechanism to move the machining mechanism 1 and the frame 5 in the Y direction is not limited to a particular type and any of various types of well-known drive mechanisms, such as the rack and pinion, may be applied (FIG. 12(c) exemplarily depicts an electric motor 56 that supplies the drive mechanism with power drive).

Sealing property of the machining space WS has been described above to be maintained also when the machining mechanism 1 moves in the Y direction. In the present embodiment, the sealing property of the machining space WS is maintained also when the machining mechanism 1 moves in the Z direction.

The following details a structure that, while permitting movement of the machining mechanism 1 in the Z direction, maintains sealing property of the machining space WS.

Specifically, as depicted in FIGS. 12(a) to 12(c), the flexible surrounding cover 54 is fixed to the surface of the frame 5 on the −Z side so as to surround the machining mechanism 1. To state the foregoing differently, the flexible surrounding cover 54 has an upper end portion (end portion in the +Z direction) fixed to the frame 5.

In addition, the bottom portion cover 55 that surrounds at least the leading end portion t of the machining mechanism 1 is mounted at a lower end portion of the flexible surrounding cover 54. It is noted that, while FIG. 12(a) depicts the flexible surrounding cover 54 only on both sides in the Y direction with respect to the machining mechanism 1 for convenience sake, the flexible surrounding cover 54 actually exists on the side of the X direction, too, so as to surround the machining mechanism 1 as described above.

The flexible surrounding cover 54 is formed of what is called a bellows-like resin sheet. The flexible surrounding cover 54 has a function of isolating the drive unit (e.g., gears and motors) of the machining mechanism 1 from the machining space WS.

The bottom portion cover 55 is a metal plate having an opening to seal the leading end portion t of the machining mechanism 1 via, for example, a packing. The bottom portion cover 55 is connected to the flexible surrounding cover 54 via a well-known adhesive or the like and fixed to the machining mechanism 1 at the opening described above. As with the flexible surrounding cover 54, the bottom portion cover 55 also has a function of isolating the drive unit of the machining mechanism 1 from the machining space WS.

As depicted in FIG. 12(c), the machining mechanism 1 is fixed to a moving mount 71 and is configured to move in the Z direction as the moving mount 71 moves in the Z direction. More specifically, the moving mount 71 is movable to any position in the Z direction by a drive mechanism 72 that is driven via an electric motor 73 that is controlled by the control unit 9. It is noted that a well-known rack and pinion mechanism is incorporated for the drive mechanism 72 in the present embodiment. Any other well-known drive mechanism, such as an air cylinder, may instead be used. Additionally, for a sensor that detects a position of the machining mechanism 1 in the Z direction, an optical sensor or any other well-known type of position detection sensor may be applied.

The foregoing configuration results in the flexible surrounding cover 54 being deformed (expanded or contracted in the Z direction) so as to follow the movement of the leading end portion t of the machining mechanism 1 in the Z direction, so that the closed state of the machining space WS can be maintained even with the movement of the machining mechanism 1 in the Z direction.

The structure of the bottom portion cover 55 is not limited. The bottom portion cover 55 is required only to be configured such that the leading end portion t of the machining mechanism 1 can be inserted in the machining space WS and sealing property can be maintained as much as feasible.

The present embodiment, in which the drive unit of the machining mechanism 1 is isolated from the machining space WS to thereby maintain sealing property of the machining space WS using the variable cover 52 and the take-up units 53, is illustrative only and not limiting. For example, instead of the variable cover 52 and the take-up units 53, bellows sheets that are expandable in the Y direction are disposed such that first ends of the bellows sheets are disposed at the +Y side and the −Y side of the machining mechanism 1 and second ends thereof are fixed to the edges of the opening 35a described above.

In accordance with the first embodiment described above, an operator site in which the operator resides and the drive unit (the drive unit of the drive mechanism 4 and the drive unit of the machining mechanism 1) of the cutting apparatus can be isolated from the machining area (machining space WS) where dust particles are produced from the workpiece being machined.

As a result, effects from the dust particles on the operator can be reduced and a service life of the drive unit of the machine can be prevented from being shortened.

### Second Embodiment

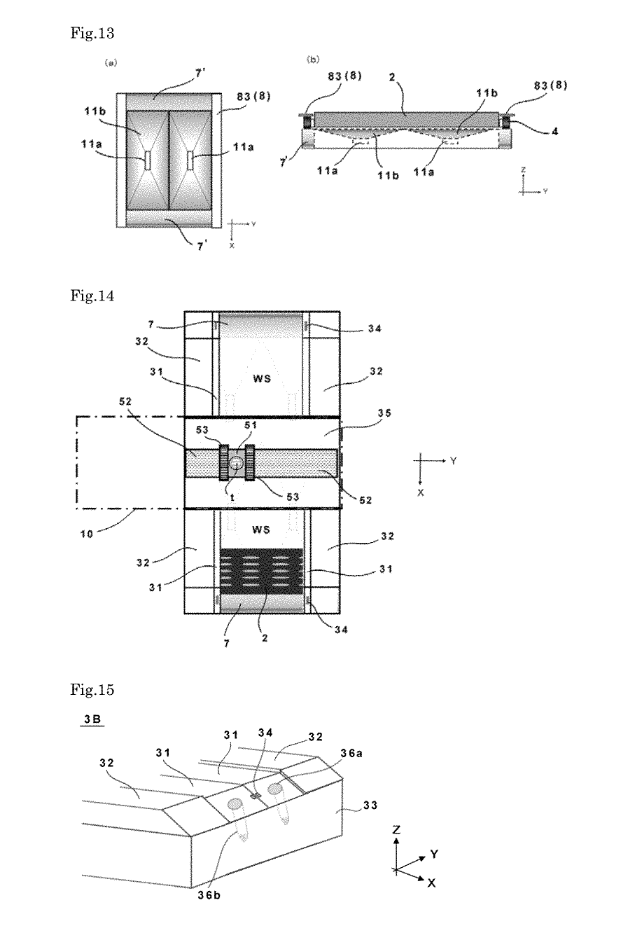

A cutting apparatus ME according to a second embodiment of the present invention will be described below with reference to FIG. 13.

Only differences from the first embodiment described above will be described in the following. Like or corresponding elements are identified by the same reference numerals as those used in the first embodiment and descriptions for those elements will be omitted as appropriate.

The cutting apparatus ME according to the second embodiment differs at least from the cutting apparatus ME in the first embodiment in that the cutting apparatus ME in the second embodiment includes a suction unit 11 that can recover swarf produced from a workpiece in a machining space WS.

Specifically, as depicted in FIG. 13(a), a mount 7′ in the present embodiment includes the suction unit 11. The suction unit 11 has suction ports 11a and suction recesses 11b that guide the swarf to the suction ports 11a.

The suction ports 11a are connected with pipes and a vacuum generating source not depicted. Swarf including wooden pieces produced in the machining space WS is drawn through the suction ports 11a. The present embodiment is thus configured such that the swarf is drawn by a vacuum generated by the vacuum generating source through the suction ports 11a and to be discharged to an outside of the machining space WS.

As evident from FIG. 13(b), the suction recesses 11b form taper surfaces to join the suction ports 11a. The taper surfaces are inclined from an upper surface of the mount 7′ toward the suction ports 11a.

In the present embodiment, the suction ports 11a are disposed at a position lower in height than a placement base 2 and the suction recesses 11b as the taper surfaces are disposed around the respective suction ports 11a. This arrangement allows the swarf to readily slide over the taper surfaces into the suction ports 11a, enabling efficient recovery of the swarf.

It is noted that the suction ports 11a are not necessarily required to be connected with the vacuum generating source and the vacuum generating source may be omitted as appropriate.

A control unit 9 controls to start a suction operation when a slide cover 31 is closed to bring the machining space WS into a closed state. This operation sets the machining space WS in a negative pressure state at all times, so that the swarf can be prevented from being unintentionally airborne outside the machining space WS.

While two suction ports 11a are juxtaposed in the Y direction in the present embodiment, the number of suction ports 11a is not limited to a particular number and may be one, or three or more.

Timing at which the suction operation by way of the suction ports 11a is started is not limited to timing when the machining space WS is set into the closed state. The suction operation may be started at any other timing. The suction operation may be started when, for example, a tool of a machining mechanism 1 is inserted into the machining space WS or when machining of the workpiece is started.

While the suction recesses 11b are disposed immediately near the placement base 2 in the present embodiment, an adequate clearance (distance) is provided between the placement base 2 and the suction recesses 11b when the placement base 2 is rotatable as in a modification to be described later.

While the present invention has been particularly described with reference to the first and second embodiments, it will be understood that various changes in form and detail may be made in the embodiments without departing from the spirit and scope of the invention.

Preferable modifications of the first and second embodiments will be described with reference to relevant drawings as appropriate. Again, like or corresponding elements are identified by the same reference numerals as those used in the embodiments described above and descriptions for those elements will be omitted as appropriate.

First Modification

FIG. 14 is a schematic view of an open/close covering member 3A according to a first modification as viewed from above.

The open/close covering member 3A in the first modification differs from the open/close covering member 3 according to each of the above-described embodiments in a length and a configuration in the X direction.

More specifically, the configuration includes an exterior cover 10, under which a machining mechanism 1 and the like are housed, and an open/close covering member 3 disposed on each side in a direction, in which a placement base 2 moves, across the exterior cover 10. To state the foregoing differently, the open/close covering member 3A includes two open/close covering members 3 joined to each other in a symmetrical structure and a slide cover 31 and a handle 34 are disposed on either side of the exterior cover 10 in a direction (X direction) in which the placement base 2 moves.

Thus, in the first modification, the operator may perform a workpiece change procedure on whichever side that suits him or her in the X direction, so that a greater degree of freedom can be achieved in layout of, for example, a plurality of apparatuses machining workpieces.

While the first modification includes only one placement base 2, two placement bases 2 may be connected with a drive mechanism 4. A control unit 9 may then be able to perform machining using the machining mechanism 1 that machines a workpiece placed on one placement base 2, while workpieces are changed or adjustments are performed on another placement base 2. This arrangement enables change and machining of workpieces concurrently with each other in, for example, a machining process requiring high throughput.

Additionally, in the first modification, the open/close covering member 3 on the +X direction side of the exterior cover 10 has a size substantially identical to a size of the open/close covering member 3 on the −X direction side of the exterior cover 10. The size may nonetheless be different from each other.

Second Modification

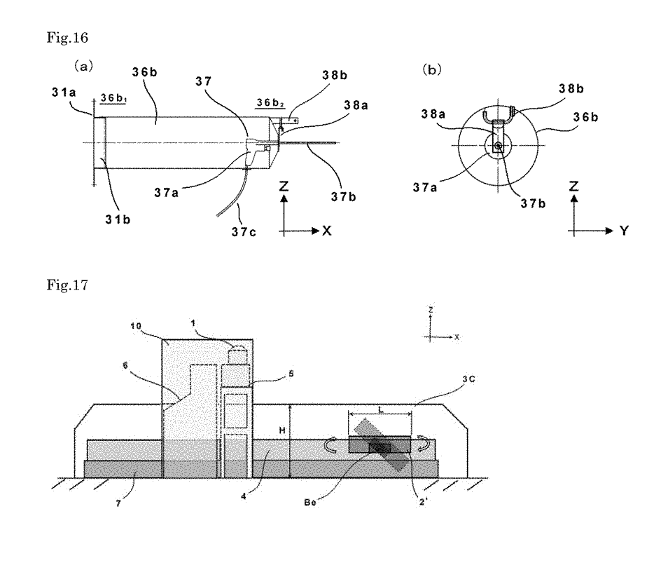

An open/close covering member 3B according to a second modification will be described below with reference to FIGS. 15 and 16.

The open/close covering member 3B according to the second modification differs from the open/close covering member in each of the embodiments and the first modification described above in that the open/close covering member 3B has at least a work hole 36a and includes a manipulator 36b, and a gas jet unit 37.

Specifically, as depicted in FIG. 15, the work hole 36a and the manipulator 36b connected with the work hole 36a are added to each of slide covers 31 of the open/close covering member 3B in the second modification.

The work hole 36a is a circular hole having a diameter through which a hand of the operator can be inserted.

The manipulator 36b includes, for example, a flexible resin glove, a proximal end portion 36b₁ and a distal end portion 36b₂. Specifically, the proximal end portion 36b₁ is connected with the work hole 36a. The distal end portion 36b₂ has a shape to correspond to the hand of the operator. It is noted that the proximal end portion 36b₁ may include a mounting plate 31a that has a protrusion 31b having a circular hole corresponding to the work hole 36a, so that the protrusion 31b and one end of the resin glove may be sealed with, for example, a well-known fastening material (e.g., hose band) as depicted in FIG. 16(a). This arrangement allows, as depicted in FIG. 15, a surface of the mounting plate 31a opposite to the protrusion 31b to be fixed to a mounting surface of the slide cover 31 on the side of a machining space WS via well-known fastening means (e.g., bolt).

It is noted that the manipulator 36b is not necessarily required to include the mounting plate 31a having the protrusion 31b and a configuration may, for example, be possible in which the above-described mounting surface of the slide cover 31 serves as the mounting plate 31a. In this case, the protrusion 31b may be formed on the mounting surface of the slide cover 31.

The operator reaches his or her hands into the manipulators 36b via the work holes 36a to thereby be able to perform predetermined work (e.g., eliminating positional deviation in the workpiece and adjusting tools in a simplified way) within the machining space WS, while maintaining a closed state of the machining space WS under the open/close covering member 3B.

Additionally, when, for example, the machining space WS is regulated by a control unit 9 to maintain a negative pressure state with respect to the outside (outside the machining space WS), an adjustment work can be performed without the need to cancel the once-established negative pressure state.

The open/close covering member 3B in the second modification may further include a fluid control unit 37 as depicted in FIG. 16.

Specifically, the fluid control unit 37, though not required, is particularly preferable for cleaning the inside of the machining space WS using the manipulators 36b. In this case, the manipulators 36b are configured to have a shape and a size to reach the fluid control unit 37.

A main part 37a of the fluid control unit 37 is housed inside the distal end portion 36b₂ of the manipulator 36b. Additionally, the fluid control unit 37 is disposed inside the distal end portion 36b₂ of the manipulator 36b such that a nozzle 37b of the fluid control unit 37 protrudes from the distal end portion 36b₂ of the manipulator 36b so that at least part thereof is positioned in the machining space WS.

These arrangements enable the operator to directly hold and operate the main part 37a of the fluid control unit 37 by hand and to keep his or her hands isolated from the machining space WS.

In addition, in the second modification, a hook member 38a is disposed at the distal end portion 36b₂ of the manipulator 36b and a catch member 38b is disposed at a portion corresponding to the slide cover 31 facing the machining space WS. This configuration prevents the fluid control unit 37, when not in use, from inadvertently colliding against a placement base 2 or a workpiece.

It is noted that examples of the fluid control unit 37 include, but are not limited to, a unit that jets or draws a gas and a unit that jets or draws a liquid. Examples of the gas to be jetted include, but are not limited to, air, vapor, and an inert gas such as nitrogen. Examples of the liquid to be jetted include, but are not limited to, water, vapor, and a medical solution such as a cleaning solution. Thus, the fluid control unit 37 is connected with a positive pressure pump or a negative pressure pump, as appropriate, depending on intended use thereof including jetting and drawing. For example, when the fluid control unit 37 depicted in FIG. 16(a) is an air gun, a fluid pipe 37c is a gas guide pipe that guides compressed air.

The location at which the fluid control unit 37 is disposed is not limited to the distal end portion 36b₂ of the manipulator 36b. Possible locations at which the fluid control unit 37 is disposed are within reach of the manipulator 36b, including sites on a mount 7 (see FIG. 6) and on the placement base 2.

The following description exemplifies the fluid control unit 37 with the gas jet unit 37. The gas guide pipe described above is connected with the gas jet unit 37 and the operator can withdraw the gas jet unit 37 in any desired direction via the manipulator 36b.

Such as gas jet unit 37 achieves the following benefits. Specifically, swarf (including dust particles, for example) produced during machining of a workpiece may be charged with static electricity due to friction and can stick to a wall and other places inside the machining space WS. Additionally, the machining space WS is typically a cube and the swarf produced during machining tends to accumulate at corners of the machining space WS. In such cases, jetting a gas using an automatically controlled air nozzle or similar device is likely to result in the jetted gas failing to reach the swarf or in the jetted gas reaching, but failing to efficiently remove, the swarf.

Because the gas jet unit 37 is disposed inside the machining space WS, the operator can reach his or her hands into the manipulators 36b and hold and operate the gas jet units 37 easily. Thus, the swarf that is accumulated inside the machining space WS can be efficiently removed with the jetted gas.

In addition, the operator resident in the work area can blow off the swarf while the machining space WS in which swarf is produced keeps closed. Thus, the blown swarf will not reach the operator and effects of the swarf on the operator can be shut down.

Third Modification

A placement base 2′ and an open/close covering member 3C according to a third modification will be described below with reference to FIG. 17.

A cutting apparatus ME according to the third modification is characterized in that, as compared with each of the embodiments and modifications described above, the cutting apparatus ME includes at least the placement base 2′ that is movable in the X direction and rotatable about a Y-axis and the open/close covering member 3C under which the placement base 2′ is housed.

Specifically, the placement base 2′ in the third modification is held by a bearing Be at a connection site with a drive mechanism 4 and is thereby rotatable about the Y-axis direction. To state the foregoing differently, the drive mechanism 4 in the third modification has a function of rotatably supporting the placement base 2′ on the outside of a machining space WS.

At this time, let L be a width in the first direction (X direction) in which the placement base 2′ moves and let H be a height in the third direction (Z direction) as a height direction of the open/close covering member 3C. Then, H>L holds.

Additionally, let Th be a thickness of the placement base 2′ in the height direction (third direction). Then, preferably, a relation of H>L+Th holds.

Preferably, the drive mechanism 4 is provided with a posture detection sensor (not depicted) that detects posture of the placement base 2′. A control unit 9 may adjust a rotating angle of the placement base 2′ using a detection result of the posture detection sensor. More specifically, examples of the posture detection sensor include, but are not limited to, a well-known optical sensor including a photo sensor and a magnetic sensor utilizing magnetism.

Additionally, because the placement base 2′ in the third modification is rotatable, the open/close covering member 3C is configured to have a height (Z direction) that permits rotation of the placement base 2′.

In accordance with the third modification described above, the rotation of the placement base 2′ enables swarf left on the placement base 2′ to be shaken off and removed.

Miscellaneous Modifications

The second modification has been described to include the fluid control unit 37 disposed inside the machining space WS. A cleaning member including an electrically or manually operated brush may be disposed inside the machining space WS, in addition to or in place of the fluid control unit 37.

In preparation for a situation in which the swarf firmly sticks by static electricity to surfaces inside a closed space, an ionizer that can simply emit ions required for neutralizing charge may be disposed.

Additionally, the work holes 36a and the manipulators 36b may be disposed in pairs in the Z direction. The work holes 36a and the manipulators 36b may even be disposed in pairs in, for example, the X direction.

Additionally, in each of the embodiments and the modifications described above, the machining space WS may be kept in a state of pressure slightly negative with respect to the outside using, for example, a combination of a vacuum generating unit, such as a pump, and a blower not depicted. This arrangement can prevent the swarf produced through machining of the workpiece from being unintentionally airborne outside the machining space WS even with a slight gap.

While the present invention has been described with reference to the specific embodiments and modifications, it should be understood that the cutting apparatus ME may be achieved through an appropriate combination of the different configurations of the above-described embodiments and the modifications.

Additionally, the present invention, while having been exemplified by a cutting apparatus, can be applied also to machining apparatuses including three-dimensional (3D) printers and other shaping apparatuses.

### INDUSTRIAL APPLICABILITY

As described heretofore, the machining apparatus of the present invention is suitable for highly efficient and low cost machining and applicable to various types of machining fields including three-dimensional shaping, in addition to cutting, grinding, and other cutting operations.

### REFERENCE SIGNS LIST

1 Machining mechanism
1b ATC
2, 2′ Placement base
2a Placement portion
2b Leg portion
3, 3A, 3B, 3C Open/close covering member
4 Drive mechanism
5 Frame
6 Double housing column
7, 7′ Mount
8 Isolation unit
9 Control unit
10 Exterior cover
10a Transparent member
10b Lateral surface
11 Suction unit
11a Suction port
11b Suction recess
31 Slide cover
31a Cover mounting surface
31b Protrusion
32 Fixed cover
33 Lower cover
34 Handle
35 Upper surface plate
35a Opening
36a Work hole
36b Manipulator
37 Fluid control unit
37a Main part
37b Nozzle
37c Fluid pipe
41 Electric motor
42 Motor mounting portion
43 Pinion
44 Rack
45 Cableveyor
46 Vacuum pipe
47 Mounting shaft
51 Opening
52 Variable cover
53 Take-up unit
54 Flexible surrounding cover
55 Bottom portion cover
56 Electric motor for Y direction drive
61 Rear plate
62 Discharge port
71 Moving mount
72 Drive mechanism for Z direction
73 Electric motor
80 Post
81 Roll unit
82 Screen member
83 Partition member
84 Suction mechanism
85 Height adjustment member
WS Machining space
GR Guide
Vc Workpiece attraction port
Be Bearing
t Leading end portion of machining mechanism 1

1-9. (canceled)

10. A cutting apparatus comprising:
a machining mechanism that machines a workpiece;
a placement base that is disposed to face the machining mechanism in a machining space and that is movable in a first direction with the workpiece placed thereon;
an open/close covering member that extends in the first direction thereby to contain therein the placement base and to form at least part of the machining space; and
a drive mechanism that is isolated from the machining space and that moves the placement base in the first direction,
wherein the open/close covering member has an opening formed in an upper surface thereof and a variable cover is disposed in the opening, and
the variable cover is deformed as the machining mechanism moves in a second direction that crosses the first direction, to thereby maintain a closed state in the machining space.

11. A cutting apparatus comprising:
a machining mechanism that machines a workpiece;
a placement base that is disposed to face the machining mechanism in a machining space and that is movable in a first direction with the workpiece placed thereon;
an open/close covering member that extends in the first direction thereby to contain therein the placement base and to form at least part of the machining space; and
a drive mechanism that is isolated from the machining space and that moves the placement base in the first direction,
wherein a screen member is provided that isolates from each other the drive mechanism and the machining space in which the placement base is disposed, and
the screen member follows movement of the placement base in the first direction to thereby be displaced, thereby maintaining an isolated state of the drive mechanism from the machining space.

12. A cutting apparatus comprising:
a machining mechanism that machines a workpiece;
a placement base that is disposed to face the machining mechanism in a machining space and that is movable in a first direction with the workpiece placed thereon;
an open/close covering member that extends in the first direction thereby to contain therein the placement base and to form at least part of the machining space; and
a drive mechanism that is isolated from the machining space and that moves the placement base in the first direction,
wherein the drive mechanism rotatably supports the placement base from an outside of the machining space.

13. The cutting apparatus according to claim 10, further comprising:
an exterior covering member connected with the open/close covering member to thereby cover the machining mechanism,
wherein the machining mechanism is movable in a second direction that crosses the first direction.

14. The cutting apparatus according to claim 10, wherein
a flexible surrounding cover is disposed around the machining mechanism and a bottom portion cover is disposed at a lower portion of the surrounding cover, the bottom portion cover surrounding at least a leading end portion of the machining mechanism, and
the flexible surrounding cover is deformed as the machining mechanism moves in a third direction that crosses the first direction and the second direction, to thereby maintain a closed state in the machining space.

15. The cutting apparatus according to claim 10, wherein
the open/close covering member includes a slide cover that is capable of relative movement in the second direction, and
the open/close covering member can be opened or closed through the movement of the slide cover in the second direction.

16. The cutting apparatus according to claim 15, wherein the slide cover has a work hole and includes a manipulator disposed at the work hole.

17. The cutting apparatus according to claim 16, further comprising:
a fluid control unit that is disposed inside the machining space and that is capable of jetting or drawing a fluid,
wherein the manipulator is shaped to reach the fluid control unit.

18. The cutting apparatus according to claim 11, further comprising:
an exterior covering member connected with the open/close covering member to thereby cover the machining mechanism,
wherein the machining mechanism is movable in a second direction that crosses the first direction.

19. The cutting apparatus according to claim 12, further comprising:
an exterior covering member connected with the open/close covering member to thereby cover the machining mechanism,
wherein the machining mechanism is movable in a second direction that crosses the first direction.

20. The cutting apparatus according to claim 11, wherein
a flexible surrounding cover is disposed around the machining mechanism and a bottom portion cover is disposed at a lower portion of the surrounding cover, the bottom portion cover surrounding at least a leading end portion of the machining mechanism, and
the flexible surrounding cover is deformed as the machining mechanism moves in a third direction that crosses the first direction and the second direction, to thereby maintain a closed state in the machining space.

21. The cutting apparatus according to claim 12, wherein
a flexible surrounding cover is disposed around the machining mechanism and a bottom portion cover is disposed at a lower portion of the surrounding cover, the bottom portion cover surrounding at least a leading end portion of the machining mechanism, and
the flexible surrounding cover is deformed as the machining mechanism moves in a third direction that crosses the first direction and the second direction, to thereby maintain a closed state in the machining space.

22. The cutting apparatus according to claim 11, wherein
the open/close covering member includes a slide cover that is capable of relative movement in the second direction, and
the open/close covering member can be opened or closed through the movement of the slide cover in the second direction.

23. The cutting apparatus according to claim 12, wherein
the open/close covering member includes a slide cover that is capable of relative movement in the second direction, and
the open/close covering member can be opened or closed through the movement of the slide cover in the second direction.
